(19) United States
(12) Patent Application Publication
(10) Pub. No.: US 2015/0018035 A1
(43) Pub. Date: Jan. 15, 2015

(54) WIRELESS TERMINAL AND WIRELESS COMMUNICATION METHOD

(71) Applicant: KYOCERA CORPORATION, Kyoto (JP)

(72) Inventor: Manabu Koizumi, Yokohama-shi (JP)

(73) Assignee: KYOCERA CORPORATION, Kyoto (JP)

(21) Appl. No.: 14/384,796

(22) PCT Filed: Mar. 13, 2013
(86) PCT No.: PCT/JP2013/056939

§ 371 Date: Sep. 12, 2014

(30) Foreign Application Priority Data
Mar. 15, 2012 (JP) 2012-059057

(51) Int. Cl. H04B 7/06

(52) U.S. Cl. CPC H04B 7/0617; H04B 7/0632
USPC 455/550.1

(57) ABSTRACT

Provided is a wireless terminal having an adaptive array antenna provided with a plurality of antennas; a weighting unit that weights each antenna from the received signals in a manner so as to form adaptive directivity in the direction of a communication target; and a control unit that causes the weighting unit to perform weighting the antennas in a manner so as to form provisional directivity when the signal quality of the received signal when the adaptive directivity has been formed does not satisfy a certain standard.

### TECHNICAL FIELD

The present invention relates to a wireless terminal performing wireless communication and a wireless communication method.

### BACKGROUND ART

In a wireless technology of mainly using time a division duplex (TDD), it is expected that a need to enable a wireless terminal to drive an adaptive array antenna system (AAS) will increase.

The reason is that, with respect to the directivity of reception of the wireless terminal, a peak of an antenna pattern of the wireless terminal is directed towards a base station or the directivity in a direction of an interfering wave is nulled, so that it is possible to improve an ability to avoid the interference upon reception of the wireless terminal. With respect to the directivity of transmission of the wireless terminal, when transmission powers of respective antennas are synthesized to sharpen the directivity, it is possible to suppress the interference with another wireless apparatus.

By the way, when increasing a circuit capacity by introducing adaptive array antennas to a base station of a mobile communication system, it is necessary to suppress the interfering wave not only in an uplink but also in a downlink. For this reason, the adaptive array antennas are used both for the transmission and for the reception and a weighting corresponding to each antenna device, which is obtained from a received signal, is used as a weighting for a transmission signal (for example, refer to Patent Literature 1).

### CITATION LIST

### Patent literature

[Patent literature 1] Japanese Patent Application Publication No. 2002-026630A

### SUMMARY OF THE INVENTION

### Technical Problem

However, when the wireless terminal is enabled to automatically drive the adaptive array antenna system, the wireless terminal and the base station may move relative to each other against the null of the antenna pattern or the intended peak. In some cases, the cancellation may be made, so that a quality of the wireless communication between the wireless terminal and the base station is deteriorated.

It is therefore an object of the present invention to provide a wireless terminal and a wireless communication method capable of preventing a quality of wireless communication from being deteriorated even when an adaptive array antenna system is driven.

### Solution to Problem

A wireless terminal of the present invention includes an adaptive array antenna having a plurality of antennas; a weighting unit weighting each antenna from received signals so as to form adaptive directivity in a direction of a communication target, and a control unit causing the weighting unit to perform weighting the respective antennas so as to form provisional directivity if a signal quality of the received signal in a case where the adaptive directivity has been formed does not satisfy a certain standard.

In the wireless terminal of the present invention, the provisional directivity may be omni-directivity.

In the wireless terminal of the present invention, the provisional directivity may be intermediate directivity having directivity between the adaptive directivity in the direction of the communication target and omni-directivity.

In the wireless terminal of the present invention, the control unit may select any one of the omni-directivity and the intermediate directivity, depending on the signal quality of the received signal.

In the wireless terminal of the present invention, the intermediate directivity may include a plurality of directivities, and the control unit may select any one of the plurality of directivities, depending on the signal quality of the received signal.

In the wireless terminal of the present invention, the certain standard may be set based on a signal quality just before the adaptive directivity is formed.

In the wireless terminal of the present invention, the certain standard may be set based on a signal quality when omni-directivity is formed.

A wireless communication method according to another aspect of the present invention is a wireless communication method of a wireless terminal including an adaptive array antenna having a plurality of antennas and a weighting unit weighting each antenna from received signals so as to form adaptive directivity in a direction of a communication target. The method includes steps of determining whether a signal quality of a received signal in a case where the adaptive directivity has been formed satisfies a certain standard, and causing the weighting unit to perform weighting the respective antennas so as to form provisional directivity if the signal quality of the received signal does not satisfy a certain standard.

A wireless terminal according to another aspect of the present invention includes an adaptive array antenna having a plurality of antennas; a weighting unit weighting each antenna from received signals so as to form adaptive directivity in a direction of a communication target, and a control unit causing the weighting unit to perform weighting the respective antennas so as to form any one of adaptive directivity, omni-directivity and provisional directivity between the adaptive directivity and the omni-directivity, depending on a signal quality of a received signal when the adaptive directivity has been formed.

### Advantageous Effects of the Present Invention

The wireless terminal and the wireless communication method of the present invention can suppress a quality of wireless communication from being deteriorated even when the adaptive array antenna system is driven.

### BRIEF DESCRIPTION OF THE DRAWINGS

FIG. 1 is a schematic view of a wireless communication system according to a first illustrative embodiment of the present invention.

FIG. 2 is a block diagram of a wireless terminal according to the first illustrative embodiment of the present invention.

FIG. 3 is a flowchart of the wireless terminal according to the first illustrative embodiment of the present invention.

FIG. 4 is a schematic view of the wireless communication system when there is an AAS synergy effect.

FIG. 5 is a schematic view of the wireless communication system when there is no AAS synergy effect.

FIG. 6 is a schematic view of a wireless communication system according to a second illustrative embodiment of the present invention.

FIG. 7 is a block diagram of a wireless terminal according to the second illustrative embodiment of the present invention.

FIG. 8 is a flowchart of the wireless terminal according to the second illustrative embodiment of the present invention.

### DETAILED DESCRIPTION OF ILLUSTRATIVE EMBODIMENTS

Hereinafter, illustrative embodiments of the present invention will be described with reference to the drawings.

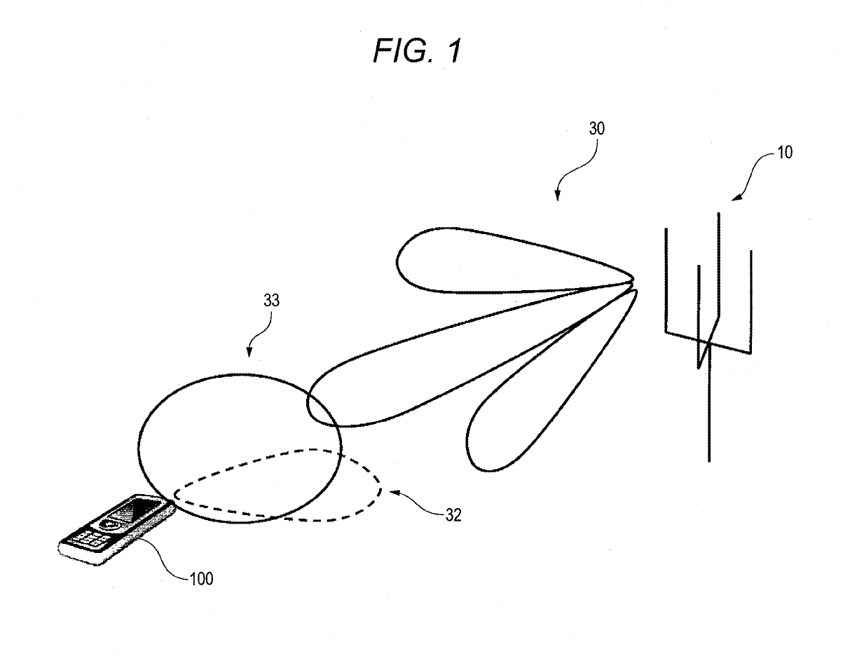

FIG. 1 is a schematic view of a wireless communication system according to a first illustrative embodiment of the present invention. In the wireless communication system, a wireless terminal 100 and an antenna 10 of a base station are shown. In the wireless communication system, the communication is performed using a time division duplex (TDD). However, it should be noted that the present invention is not limited to the TDD.

In FIG. 1, when the wireless terminal 100 drives an AAS to form an antenna pattern 32 upon starting of the wireless terminal 100 with respect to an antenna pattern 30 formed by the antenna 10 of the base station, the wireless terminal 100 corrects the antenna pattern 32 to apply an antenna pattern 33 having an omni-operation (omni-directivity: there is no directivity), thereby suppressing a communication quality from being deteriorated.

The antenna pattern (radiating pattern) shows a radiating characteristic of an antenna. The antenna pattern illustrates how the antenna radiates (or receives) the energy in a space. In order to radiate the energy in all directions (at least to some extent), the antenna pattern becomes actually a three-dimensional pattern. However, a planar pattern is here shown.

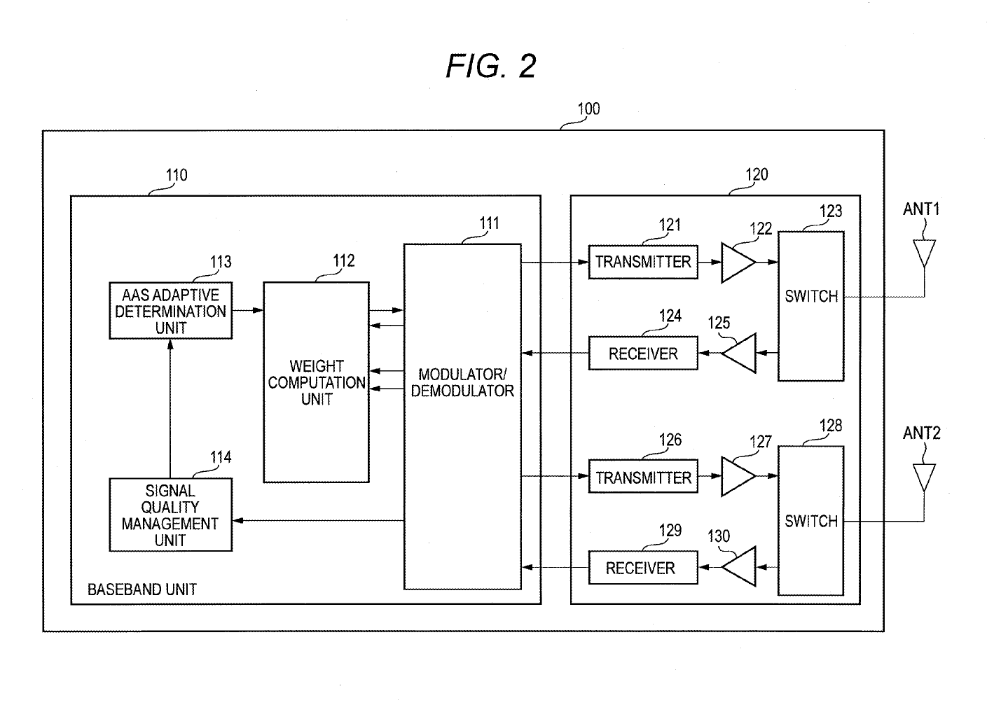

FIG. 2 is a block diagram of the wireless terminal according to the first illustrative embodiment of the present invention. The wireless terminal 100 has a baseband unit 110 and a wireless unit 120. In the meantime, the wireless terminal of the illustrative embodiment of the present invention also has other parts such as an input/output device and the like, which are not here shown.

The wireless unit 120 has transmitters 121, 126, power amplifiers 122, 127, receivers 124, 129, low-noise amplifiers 125, 130 and switches 123, 128.

The transmitters 121, 126 are respectively configured to transmit a wireless signal so that a signal modulated in the baseband unit 110 can be propagated with a predetermined frequency. The power amplifiers 122, 127 are respectively configured to amplify signals output from the transmitters 121, 126.

The switch 123 is configured to switch a connection between an antenna ANT1 and the power amplifier 122 or a connection between the antenna ANT1 and the low-noise amplifier 125 at predetermined timing. The switch 128 is configured to switch a connection between an antenna ANT2 and the power amplifier 127 or a connection between the antenna ANT2 and the low-noise amplifier 130 at predetermined timing.

The low-noise amplifiers 125, 130 are respectively configured to amplify the signals from the antennas and to output the same to the receivers 124, 129. The receivers 124, 129 are respectively configured to process the amplified signals and to output the same to the baseband unit 110.

In the meantime, with respect to the transmission and reception system of the wireless unit 120, the two systems are shown. However, three or more systems may be configured.

The baseband unit 110 has a modulator/demodulator 111, a weight computation unit 112, an AAS adaptive determination unit 113 and a signal quality management unit 114.

The modulator/demodulator 111 is configured to demodulate the signals received at the receivers 124, 129. Also, the modulator/demodulator 111 is configured to modulate a signal upon transmission.

The signal quality management unit 114 is configured to manage a change or changes of one or more of SINR (Signal to Interference and Noise Ratio), CQI (Channel Quality Indicator), MCS (Modulation and Coding Scheme), RSSI (Receive Signal Strength Indicator) and signal power of the signal demodulated by the modulator/demodulator 111.

The weight computation unit 112 is configured to compute the signals received from the respective adaptive array antennas ANT1, ANT2 and to perform weighting the respective adaptive array antennas ANT1, ANT2 so as to drive an adaptive array system.

The AAS adaptive determination unit 113 determines whether or not to form provisional directivity, and for example determines whether or not to apply the omni-operation (omni-directivity), depending on a situation of a received signal quality by the driving of the adaptive array system.

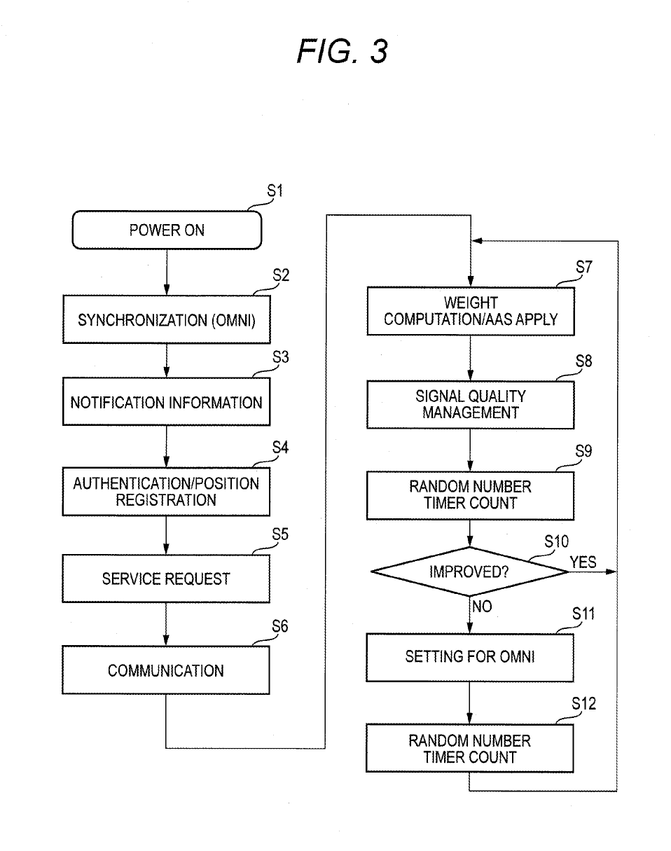

FIG. 3 is a flowchart of the wireless terminal according to the first illustrative embodiment of the present invention.

When power is applied to the wireless terminal 100 (S1), the wireless terminal 100 performs a cell search and is synchronized with a base station having a good signal quality by the omni-operation (S2).

The wireless terminal 100 acquires notification information (S3), performs authentication/position registration (S4), requests a service (S5) and starts to perform communication with the base station (S6).

At this time, the weight computation unit 112 computes the signals received from the adaptive array antenna and weights each antenna (S7). At this situation, the wireless terminal 100 forms sharp directivity (adaptive directivity) so as to form directivity in a direction of a communication target. In the meantime, the sharp directivity means the directivity stronger than the provisional directivity and does not necessarily mean the strength of the specific directivity.

Thereafter, the wireless terminal 100 performs the signal quality management in the signal quality management unit 114 (S8). When a timer by a count value determined with a random number expires (S9), the wireless terminal performs comparison and determination processing of the quality value managed in the signal quality management unit 114 and a predetermined threshold, in the AAS adaptive determination unit 113 (S10). Here, the predetermined threshold may be a preset value, a quality value (SINR, CQI, MCS or RSSI) just before the formation of the sharp directivity or an average quality value when performing communication with the omni-operation.

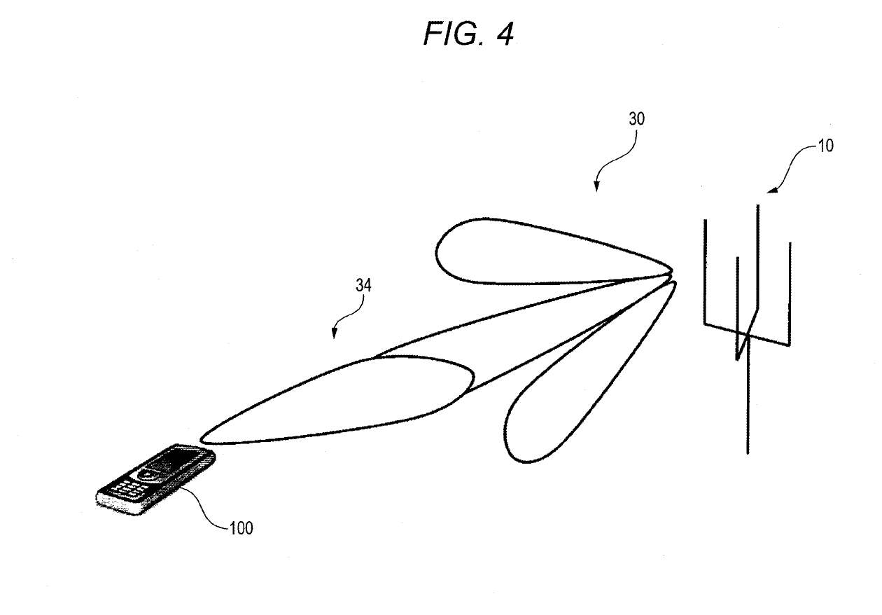

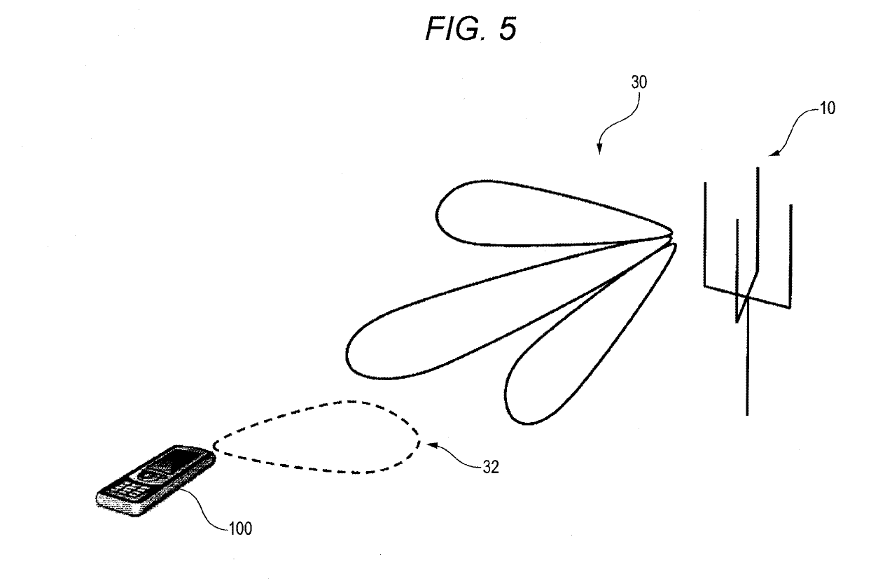

As a result, when it is determined that the quality value is larger than the predetermined threshold and the signal quality is thus improved, the current directivity is continued. That is, as shown in FIG. 4, it is determined that this situation has an AAS synergy effect. On the other hand, when the signal quality is deteriorated, it is regarded that there is no AAS synergy effect, as shown in FIG. 5.

If it is determined that the signal quality is deteriorated in a case where the sharp directivity is formed, the AAS adaptive determination unit 113 determines to apply the omni-operation so as to form the provisional directivity, and the weight computation unit 112 sets a weight for omni-operation (S11). As shown in FIG. 1, this situation indicates that the antenna pattern 33 having the omni-operation (omni-directivity: there is no directivity) is applied to suppress a communication quality from being deteriorated. Also, the timer by the count value determined with a random number starts (S12) and the weight computation and the AAS operation are again performed.

The timer in S9 and S11 is used not to be affected by whether the wireless terminal 100 is being moved or whether there is a fading. Also, the counter value of the timer is determined with a random number from a preset range.

As described above, the wireless terminal of the first illustrative embodiment of the present invention compares the effects of the transmission and reception in the AAS driving and the transmission and reception in the omni-operation (omni-directivity: there is no directivity) and then performs the switching. Therefore, it is possible to suppress the quality deterioration of the wireless communication and the divergence of the system. Further, the null and peak of the antenna pattern are made by the AAS, so that it is possible to avoid interfering and being interfered with respect to an adjacent system.

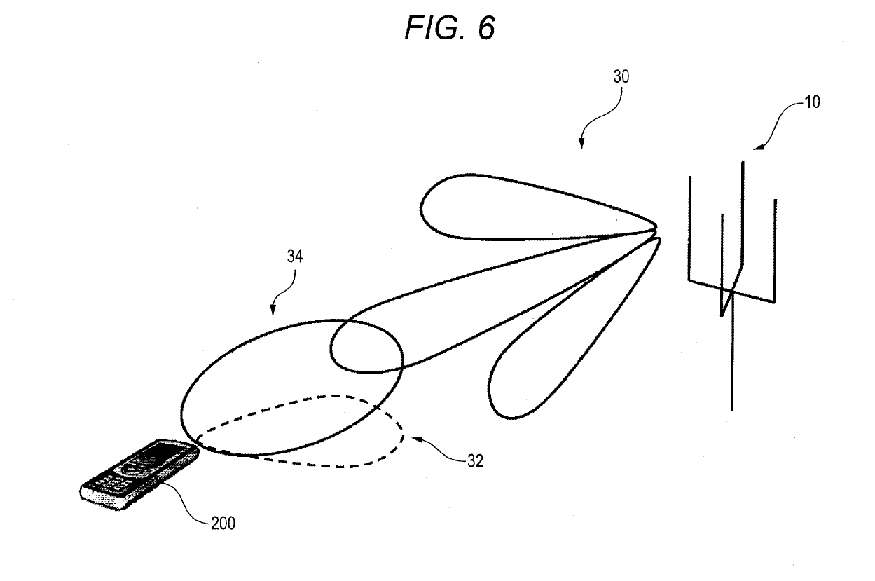

FIG. 6 is a schematic view of a wireless communication system according to a second illustrative embodiment of the present invention. In this wireless communication system, a wireless terminal 200 and the antenna 10 of the base station are shown. In the wireless communication system, the communication is performed using the time division duplex (TDD). However, it should be noted that the present invention is not limited to the TDD.

When the wireless terminal 200 drives the AAS to form the antenna pattern 32 upon starting of the wireless terminal 200 with respect to the antenna pattern 30 formed by the antenna 10 of the base station, the wireless terminal corrects the antenna pattern to apply an antenna pattern 34, thereby suppressing the deterioration.

In the first illustrative embodiment of the present invention, if the signal quality is deteriorated when the sharp directivity is formed, the wireless terminal 100 drives the AAS with the omni-operation (there is no directivity). However, in the second illustrative embodiment of the present invention, the wireless terminal 200 drives the AAS with the antenna pattern 34 having intermediate directivity between the sharp directivity and no directivity.

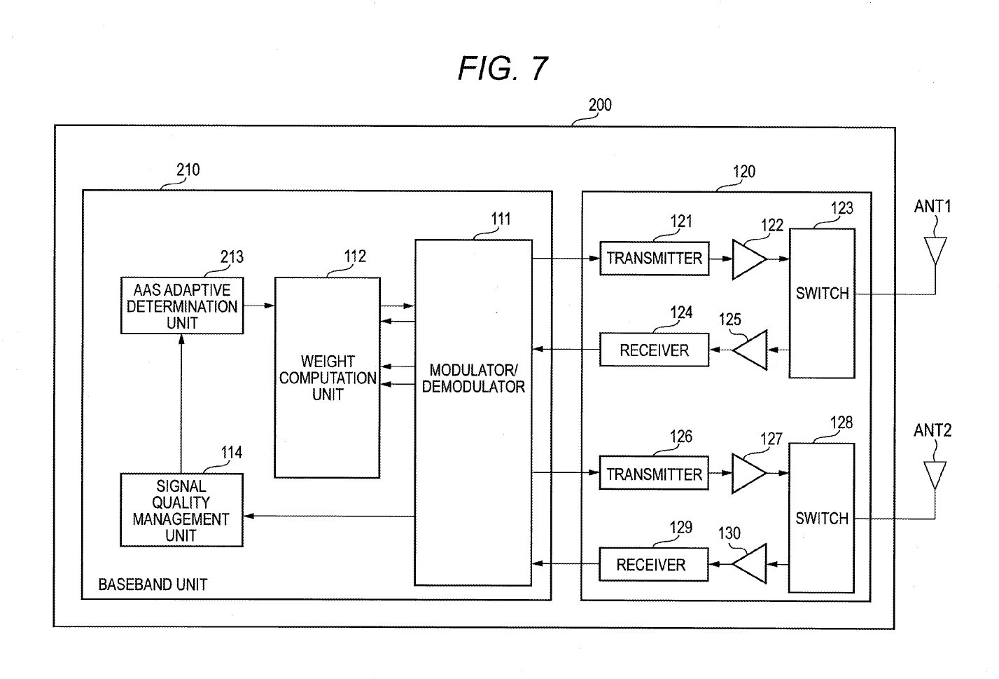

FIG. 7 is a block diagram of the wireless terminal according to the second illustrative embodiment of the present invention. The wireless terminal 200 has a baseband unit 210 and the wireless unit 120. In the meantime, the same parts as those configuring the wireless terminal 100 are denoted with the same reference numerals and the descriptions thereof are omitted.

An AAS adaptive determination unit 213 determines whether or not to form provisional directivity, and for example determines whether or not to apply the intermediate directivity, depending on the situation of the received signal quality by the driving of the adaptive array system.

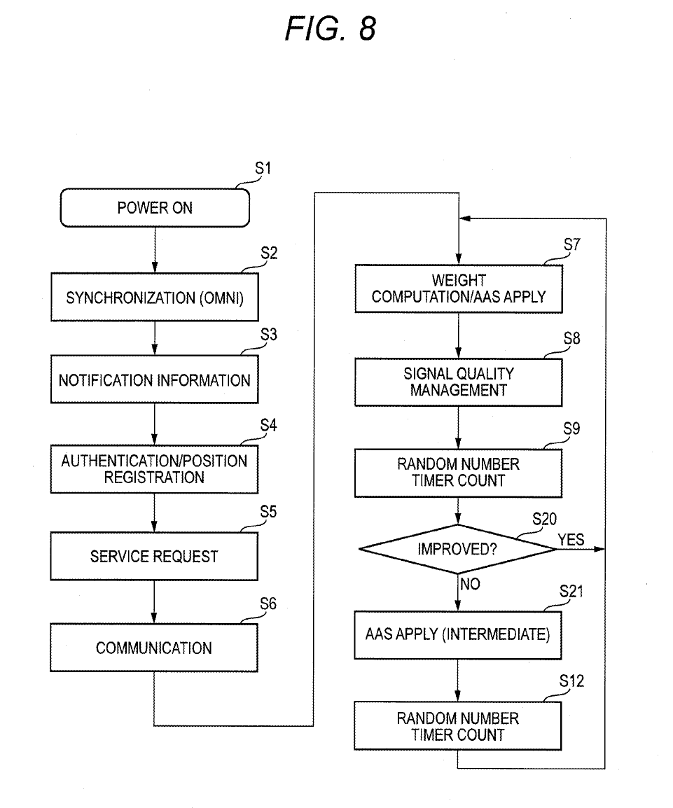

FIG. 8 is a flowchart of the wireless terminal according to the second illustrative embodiment of the present invention. Meanwhile, the same steps as the flowchart of the wireless terminal according to the first illustrative embodiment of the present invention are denoted with the same reference numerals and the descriptions thereof are omitted.

The AAS adaptive determination unit 213 performs the comparison and determination processing of the quality value managed in the signal quality management unit 114 and a predetermined threshold, in the signal quality management unit 114 (S20). Here, the predetermined threshold may be a preset value, a quality value (SINR, CQI, MCS or RSSI) just before the formation of the sharp directivity or an average quality value when performing communication with the provisional directivity.

As a result, when it is determined that the quality value is larger than the predetermined threshold and the signal quality is thus improved, the current directivity is continued. That is, as shown in FIG. 4, it is regarded that this situation has the AAS synergy effect. On the other hand, when the signal quality is deteriorated, it is regarded that there is no AAS synergy effect, as shown in FIG. 5.

If it is determined that the signal quality is deteriorated when the sharp directivity is formed, the AAS adaptive determination unit 213 determines to apply the intermediate directivity (the antenna pattern 34) so as to form the provisional directivity, and the weight computation unit 112 sets a weight for the intermediate directivity (the antenna pattern 34 (S21). As shown in FIG. 6, this situation indicates that the antenna pattern 34 is applied to suppress the communication quality from being deteriorated.

On the other hand, when it is determined that the signal quality is deteriorated, the AAS adaptive determination unit 213 may select any one of the omni-operation (the antenna pattern 33) and the intermediate directivity (the antenna pattern 34), depending on the quality value. Also, the AAS adaptive determination unit 213 may prepare intermediate directivities in a stepwise manner as well as the two patterns of the omni-operation (the antenna pattern 33) and the intermediate directivity (the antenna pattern 34), select an intermediate directivity for each step, depending on the quality value, set a weighting corresponding to the selected directivity for the weight computation unit 112 and drive the adaptive array system with the directivity having various sharps.

In the meantime, when it is determined that the signal quality is deteriorated, the AAS adaptive determination unit 213 can give the adaptive array the strength and weakness in a stepwise manner by softening (lightening the weight) and hardening (strengthening the weight), depending on the communication quality.

As described above, the wireless terminal of the second illustrative embodiment of the present invention compares the effects of the transmission and reception by the intermediate directivity and then performs the switching. Therefore, it is possible to suppress the quality deterioration of the wireless communication and the divergence of the system. Further, it is possible to cope with the moving of the wireless terminal and the fading. It is not necessary to detect the moving or moving speed and the deterioration due to the moving of the wireless terminal, which cannot be followed by the AAS, is also improved. The present application is based on Japanese Patent Application No. 2012-059057 filed on Mar. 15, 2012, the contents of which being here incorporated for reference.

### DESCRIPTION OF THE REFERENCE NUMERALS

10: antenna

30, 32, 33, 34: antenna pattern

100, 200: wireless terminal

110, 210: baseband unit

111: modulator/demodulator

112: weight computation unit

113, 213: AAS adaptive determination unit (control unit)

114: signal quality management unit

120: wireless unit

121, 126: transmitter

122, 127: power amplifier

123, 128: switch

124, 129: receiver

125, 130: low-noise amplifier

1. A wireless terminal comprising:
an adaptive array antenna having a plurality of antennas;
a weighting unit weighting each antenna from received signals so as to form adaptive directivity in a direction of a communication target; and
a control unit causing the weighting unit to perform weighting the respective antennas so as to form provisional directivity when a signal quality of the received signal in a case where the adaptive directivity has been formed does not satisfy a certain standard.

2. The wireless terminal according to claim 1,
wherein the provisional directivity is omni-directivity.

3. The wireless terminal according to claim 1,
wherein the provisional directivity is intermediate directivity having directivity between the adaptive directivity in the direction of the communication target and omni-directivity.

4. The wireless terminal according to claim 3,
wherein the control unit selects any one of the omni-directivity and the intermediate directivity, depending on the signal quality of the received signal.

5. The wireless terminal according to claim 3,
wherein the intermediate directivity comprises a plurality of directivities, and the control unit selects any one of the plurality of directivities, depending on the signal quality of the received signal.

6. The wireless terminal according to claim 1,
wherein the certain standard is set based on a signal quality just before the adaptive directivity is formed.

7. The wireless terminal according to claim 1,
wherein the certain standard is set based on a signal quality when omni-directivity is formed.

8. A wireless communication method of a wireless terminal comprising an adaptive array antenna having a plurality of antennas and a weighting unit weighting each antenna from received signals so as to form adaptive directivity in a direction of a communication target, the method comprising steps of:
determining whether a signal quality of a received signal in a case where the adaptive directivity has been formed satisfies a certain standard, and
causing the weighting unit to perform weighting the respective antennas so as to form provisional directivity if the signal quality of the received signal does not satisfy a certain standard.

9. A wireless terminal comprising:
an adaptive array antenna having a plurality of antennas;
a weighting unit weighting each antenna from received signals so as to form adaptive directivity in a direction of a communication target, and
a control unit causing the weighting unit to perform weighting the respective antennas so as to form any one of adaptive directivity, omni-directivity and provisional directivity between the adaptive directivity and the omni-directivity, depending on a signal quality of a received signal when the adaptive directivity has been formed.
